(19) United States
(12) Patent Application Publication
(10) Pub. No.: US 2025/0366457 A1
(43) Pub. Date: Dec. 4, 2025

(54) HORSE SHOE SYSTEM

(71) Applicant: EasyCare, Inc., Durango, CO (US)

(72) Inventors: Garrett Ford, Durango, CO (US); Jingcheng Lan, Durango, CO (US)

(73) Assignee: EasyCare, Inc., Durango, CO (US)

(21) Appl. No.: 19/221,105

(22) Filed: May 28, 2025

Related U.S. Application Data
(60) Provisional application No. 63/652,344, filed on May 28, 2024.
(60) Provisional application No. 63/724,803, filed on Nov. 25, 2024.

(51) Int. Cl. A01L 3/02; A01L 5/00

(52) U.S. Cl. CPC A01L 3/02; A01L 5/00

(57) ABSTRACT

A polymer horse shoe having one or more cuffs having holes. The horse shoe is configured for securement to a horse hoof with alternative means, including a liner secured with an acrylic type glue, or with a gap-filling adhesive dispensed on the cuffs and an interconnected hole/channel system.

### CROSS-REFERENCE TO RELATED APPLICATIONS

This patent application claims the priority benefit of U.S. Provisional Application Nos. 63/652,344, filed May 28, 2024, and 63/724,803, filed Nov. 25, 2024, both of which are incorporated by reference herein in their entirety.

### FIELD OF THE DISCLOSURE

This patent application relates to polymer horse shoes.

### BACKGROUND

In recent decades, the equine industry developed a number of polymeric, horse shoes with cuffs that are bonded to the hoof. One existing design is illustrated in FIGS. 1-3, which show a horse shoe having cuffs with holes. Referring to FIG. 3, the horse shoe is depicted adhered to a horse hoof using an adhesive that hardens in the cuff holes. Another exemplary horse shoe is illustrated in U.S. Pub. No. US20140231101 (Ford), titled “Glued-on Horse Boot with Frog Support.” Ford disclosed an improved horse shoe with lateral cuffs having lateral holes and interior grooves for receiving thick glues to adhere the shoes to horse hooves. In particular, the horse shoe of Ford was provided with a bottom part or horseshoe 12 that is attached to two upper side walls 14. The horseshoe 12 has interior, interconnected recesses 34 and notches 36 to receive adhesive, and thus permit a direct bond between horseshoe 12 and the bottom of a horse hoof. Additionally, the cuffs of Ford had lateral holes or perforations to allow excess glue to ooze out during the fitting process and bind to the perforations as well as the interior of the cuff.

While existing polymeric horse shoes such as depicted in FIGS. 1-3 and Ford provide considerable advantages over traditional horseshoe designs, they suffer from a number of persistent and performance-limiting drawbacks. Indeed, while the horse shoe of FIGS. 1-3 provides exceptional performance and is generally exceedingly stable and durable, it suffers from drawbacks in certain extreme circumstances. That is, from time to time, such a horse shoe may be subjected to an exceedingly hard impact or force that breaks or sheers the adhesive bond. In such cases, all or part of the horse shoe cuff can be inadvertently removed from the horse hoof. FIG. 4, for instance, illustrates a horse hoof that had a cuff inadvertently removed as a result of an exceedingly hard force. As a result, FIG. 4 depicts the horse hoof with the remnant adhesive in the form of pins. The horse shoe disclosed in Ford is likewise susceptible to undesirable or premature detachment as a result of experiencing bond-sheering forces.

What is needed, therefore, is a horse shoe that resolves or improves upon the preceding embodiments.

### SUMMARY

The present disclosure describes a horse shoe with improved hoof retention and adhesion, as well as removability. In one preferred embodiment, the horse shoe includes cuffs having holes interconnected by cross-linked channels.

In another preferred embodiment, the horse shoe is provided with cuffs and one or more liners with pegs that securely snap-fit or press-fit into the cuffs. The liner is bonded on one side to a hoof. On the other side, the liner may be used in a non-glued configuration that allows the shoe to be removed/“popped off”, or alternatively, in a glued configuration that forms a more permanent bond between the liner, the shoe and the hoof. In yet a third application that does not require a liner, the shoe may be used with a gap-filling adhesive pressed through holes interconnected by cross-linked channels.

### BRIEF DESCRIPTION OF DRAWINGS

Embodiments of the application will be described in detail in conjunction with FIGS. 5-19.

FIG. 1 is a top view of a horse shoe according to the prior art.

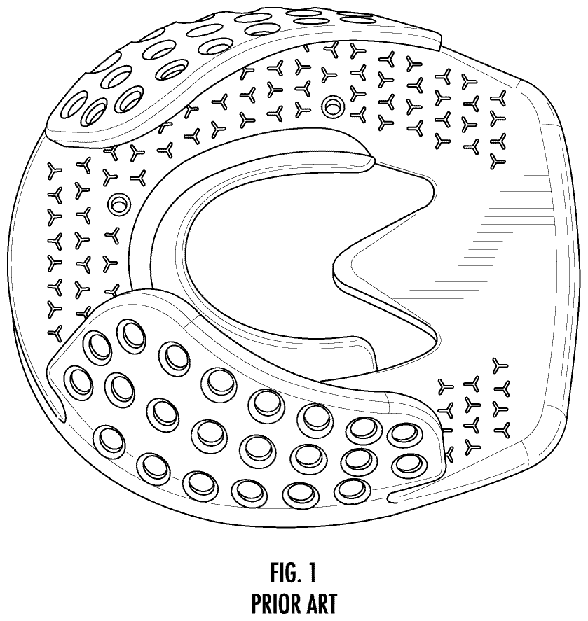

FIG. 2 is a side view of a horse shoe according to the prior art.

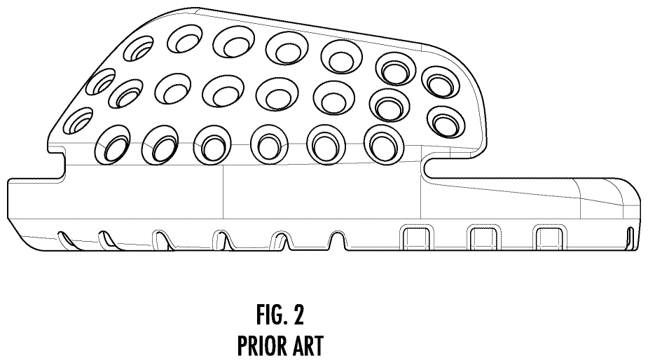

FIG. 3 is a perspective side view of a horse shoe adhered to a hoof in accordance with a prior art device.

FIG. 4 illustrates a hoof having remnant adhesive after failure of a prior art hoof boot.

FIG. 5 is a perspective side view of a horse shoe according to the disclosure.

FIG. 6 is a side view of a horse shoe according to the disclosure.

FIG. 7 is a side view of a horse shoe according to the disclosure.

FIG. 8 is a top view of a horse shoe according to the disclosure.

FIG. 9 is a front view of a horse shoe according to the disclosure.

FIG. 10 is a perspective bottom view of a horse shoe according to the disclosure.

FIG. 11 is a perspective bottom view of a horse shoe according to the disclosure.

FIG. 12 is a front view of a horse shoe on a horse hoof according to the disclosure.

FIG. 13 is a perspective side view of a horse shoe according to the disclosure.

FIG. 14 is a perspective side view of a horse shoe according to the disclosure.

FIG. 15 is a rear view of a horse shoe according to the disclosure.

FIG. 16 is a perspective side view of a horse shoe and removable interior liner according to the disclosure.

FIG. 17 is a perspective side view of a horse shoe in union with a removable interior liner according to the disclosure.

FIG. 18 is a perspective side view of a horse shoe and removable interior liner according to the disclosure.

FIG. 19 is a rear view of a horse shoe according to the disclosure.

FIG. 20 is a perspective front view of a horse shoe and chiral liners according to the disclosure.

FIG. 21 is a perspective side view of a horse shoe and a liner according to the disclosure.

FIG. 22 is a perspective top view of a liner according to the disclosure.

FIG. 23 is a perspective side view of a horse shoe with liners according to the disclosure.

FIG. 24 is a perspective front view of a horse shoe with liners according to the disclosure.

FIG. 25 is a perspective rear view of a horse shoe with liners according to the disclosure.

FIG. 26 is a perspective top view of a horse shoe with resilient cuffs partially attached to liners according to the disclosure.

### DETAILED DESCRIPTION

Other features and advantages of this disclosure will become apparent in the following detailed description of the embodiment(s) with reference to the accompanying drawings.

To aid in describing the disclosure, directional terms may be used in the specification and claims to describe portions of the present disclosure (e.g., front, rear, left, right, top, bottom, proximal, distal, superior, inferior, etc.). These directional definitions are intended to merely assist in describing and claiming the disclosure and are not intended to limit the disclosure in any way.

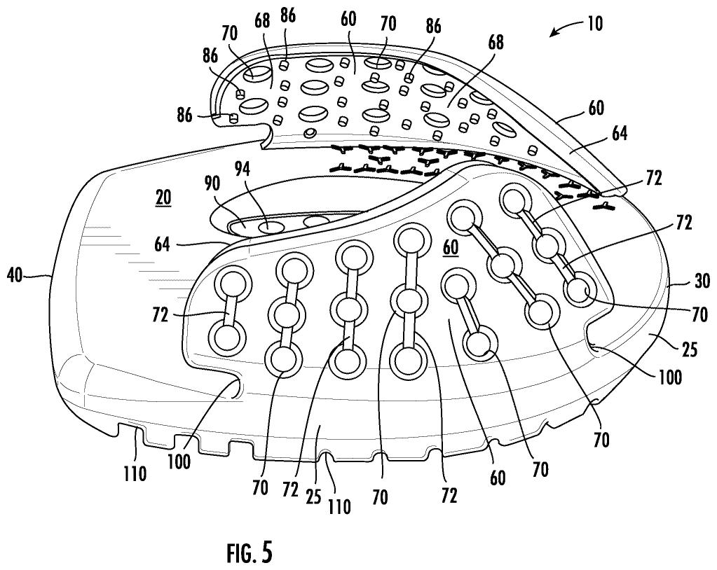

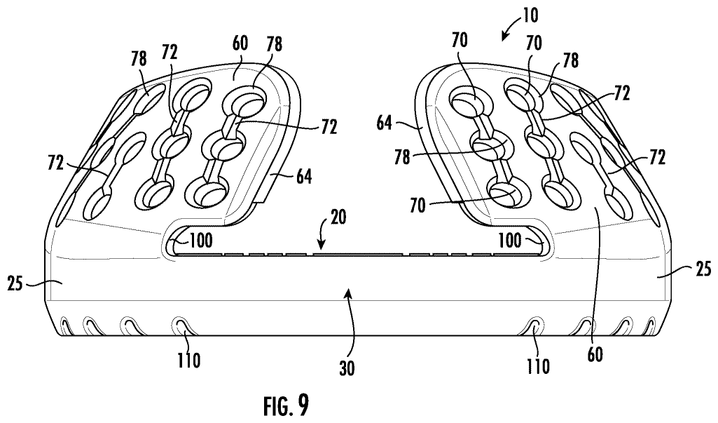

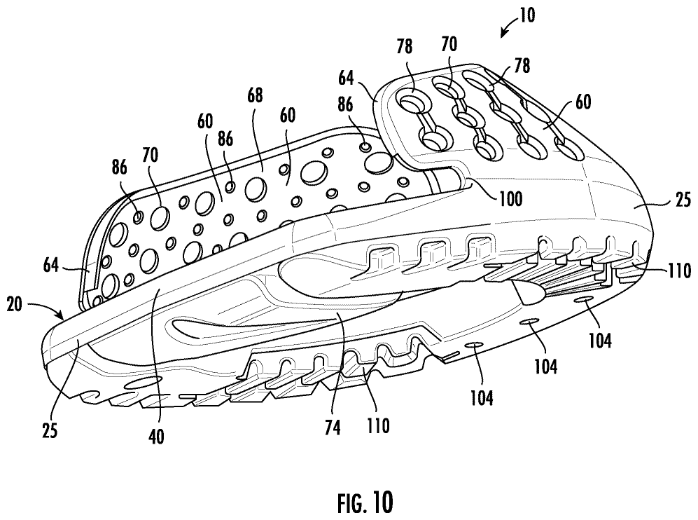

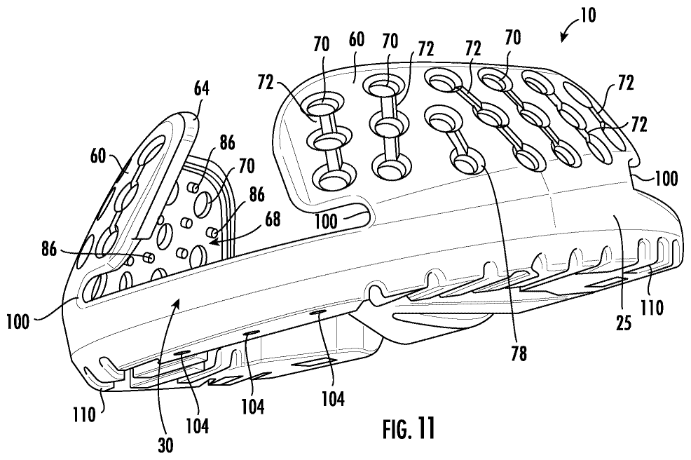

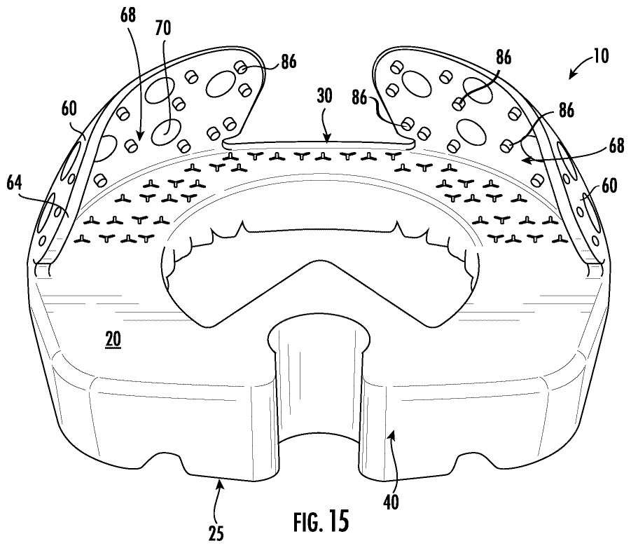

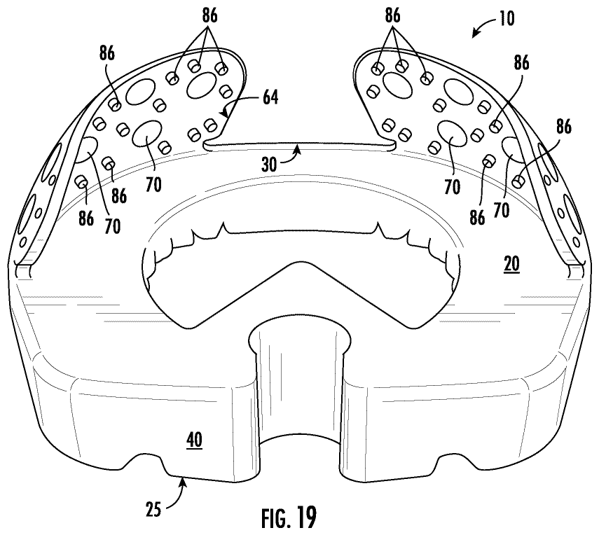

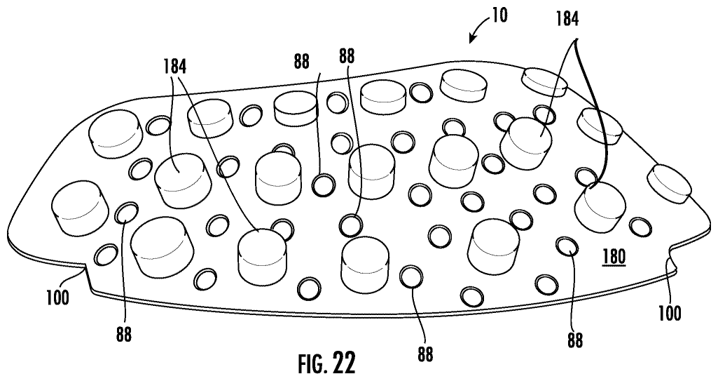

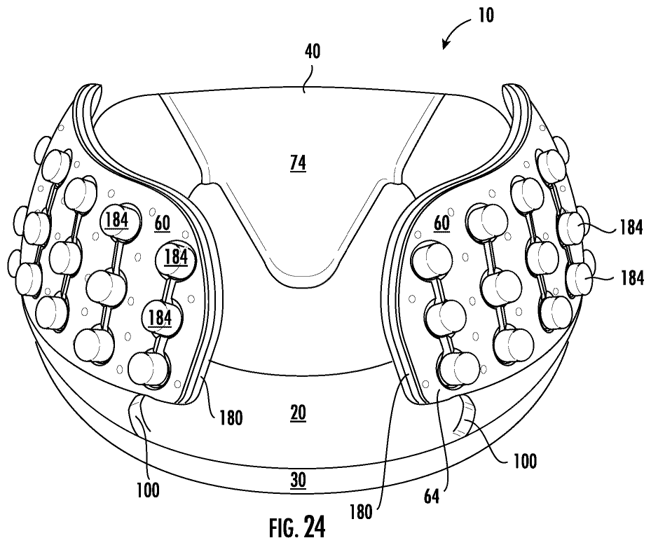

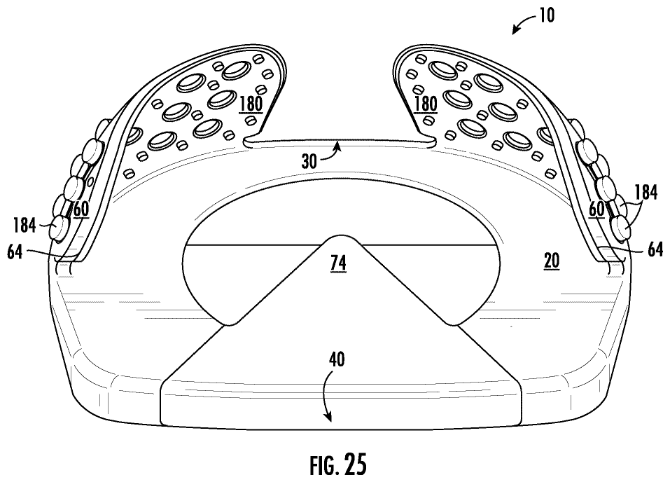

Embodiments of the present disclosure are best understood by referring to FIGS. 5-25 of the drawings, like numerals being used for like and corresponding parts of the various drawings.

### LIST OF REFERENCES

1 Horse Hoof
2 Hoof Wall
3 Toe
10 Horse Shoe
20 Horse Sole Bed
25 Sole
30 Distal End
40 Proximal End
60 Lateral Wall or Cuff
64 Rim
68 Interior Space
70 Hole
72 Furrow, Groove or Channel
74 Frog or Frog Support
78 Frustroconical Region
80 Adhesive Node
84 Adhesive Lace
86 Pin
88 Recesses
90 Stratum
94 Stratum Opening
100 Carveout
104 Sole Opening
110 Treads
120 Superior Region
130 Inferior Region
180 Liner
184 Peg
190 Fenestration

The term “horse shoe” is used to describe a lower profile shoe, without a gaiter, that may wrap only partially around the hoof of the horse. The term “sole” is defined to refer only to that part of a horse boot or shoe that covers a substantial portion of the underside of the hoof. By contrast, the term “horseshoe” is defined to refer to a structure, made of any material, that is substantially in the form of a conventional iron horseshoe that has an open heel and an interior open area corresponding substantially to the interior underside of the hoof of the horse. As described with reference to the present invention, the heel segment or portions of the heel may be connected by a bridging structure. Finally, the terms “supple” and “resilient” are used in this specification to mean capable of deforming when subjected to a bending, compressing or stretching force and of returning to the original condition when such force is released. In view of the fact that most materials exhibit some degree of resilience, for the purposes of this disclosure and of the claimed invention the term resilient is limited to materials that can be bent by at least 30 degrees without suffering any permanent deformation.

In general, as shown in FIGS. 5-26, horse shoe 10 has sole 25 and cuffs 60 extending from sole 25 or horse sole bed 20. Sole 25 has an upper surface that forms horse sole bed 20, and a lower surface with treads 110. Further, lateral wall or cuffs 60 (which can be provided a single wall extending a substantial portion of the horse shoe, or as separate lateral walls) have holes 70 extending through the cuffs. Optionally the lateral walls can be provided with a series of exterior, vertical furrows, grooves or channels 72.

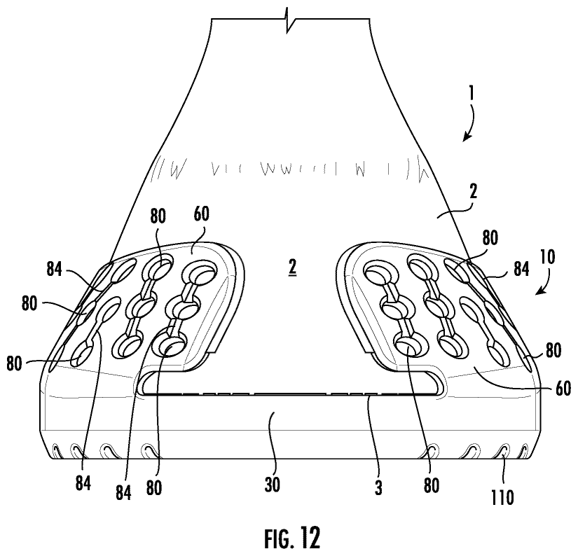

As depicted in the embodiment of FIGS. 5-12, when filled with adhesive, holes 70 form a series of nodes 80 that are interlaced or cross-linked adhesive laces 84 that extend through channels 72. Cuffs 60 also include an interior space 68 with pins 86. In use, cuffs 60 of horse shoe 10 are adhered to a horse hoof wall 2 with copious amount of adhesive. As excess adhesive is pressed out of interior space 68 through holes 70, the excess is pressed into channels 72. As shown in FIG. 12, upon curing, the adhesive forms a series of adhesive laces 84 that are interlaced between nodes 80. As a result, the adhesive forms a secure, highly durable bond and mechanical connection between cuffs 60 and the hoof wall 2.

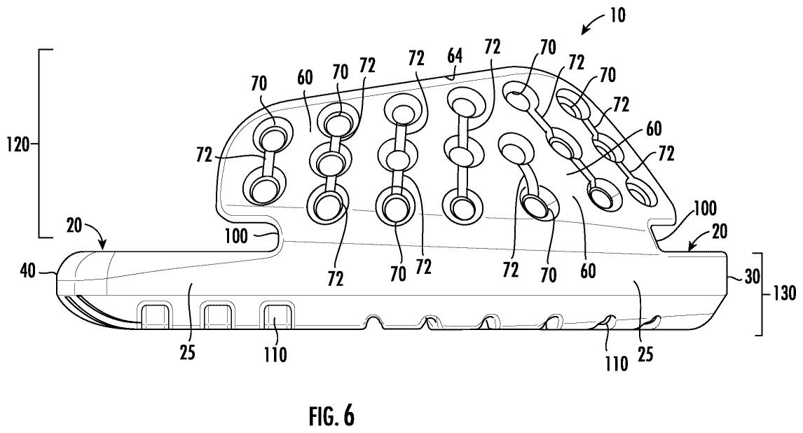

Horse shoe 10 is preferably made from a molded urethane, or other similar polymer. Preferably, horse shoe 10 is provided with a durometer between 80 A and 90 A. Referring to FIG. 6, horse shoe 10 has a superior region 120 that includes cuffs 60 and an inferior region 130 that includes sole 25. As, shown in FIGS. 5, 15 and 26, the perimeter of cuffs 60 include an interior rim 64 that defines an interior space 68 between the horse hoof 1 and cuff 60 when in use (see, for example, FIG. 12). This interior space 68 accommodates a substantial amount of thick, gap-filling adhesive as described below. Cuff 60 further includes holes 70 and a number of interior pins 86, which provide structure and support between cuff 60 and the horse hoof, as well as increased surface area for adhesive bonding. While holes 70 are circular, different shaped holes can be used in alternative embodiments of the present invention.

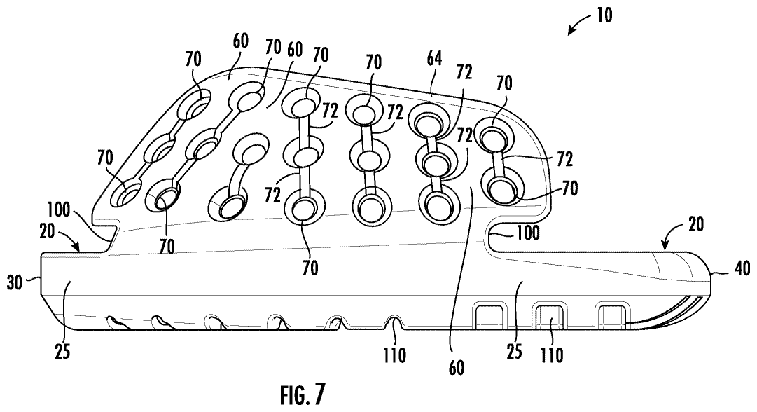

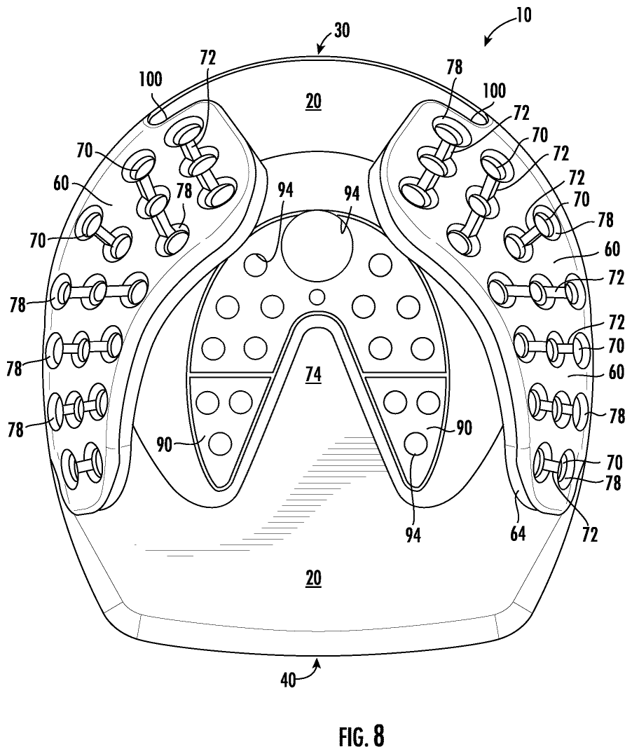

Referring to FIGS. 8-11, cuffs 60 have circular holes 70 with frustroconical regions 78. The frustroconical regions increase adhesive bonding surface area and restrict detachment or “pull through” of adhesive through holes 70 when in use. Cuffs 60 are also provided with a series of furrows, grooves or channels 72 that receive and bond with adhesive. As shown in FIG. 7, for example, channels 72 connect multiple holes 70. While channels 72 are illustrated in a vertical arrangement between holes 70, a number of alternative arrangements can be used. For example, channels 72 can extend in horizontal arrangements from hole 70 to hole 70. Similarly, channels 72 can be arranged in a web or fully cross-linked arrangement thus indirectly interconnecting all holes 70.

Referring to FIGS. 6-7, 14 and 21, cuffs 60 are provided with carveouts 100. Such carveouts dramatically improve the fit and adherence of horse shoe 10 to the horse hoof. In particular, carveouts 100 improves fit on horse hooves and adherence to horse hooves by increasing the cuff surface area adhered to the hoof, while permitting additional hoof and shoe flexion without breaking the adhesive bond. Thus, when in use, carveouts 100 allow for expansion and contraction, as well as growth of the horse hoof and extend the wearable life of the horse shoe.

In one exemplary embodiment of horse shoe 10 shown in FIGS. 5-9 and 12, sole 25 is designed to cover and naturally accommodate the weight bearing structures of a horse foot, i.e., the wall, sole and frog. Further, sole 25 extends from distal end 30 to proximal end 40, and defines a horse sole bed 20 on the upper portion of sole 25. In particular, as shown in FIG. 8, in a top view, horse sole bed 20 is formed in the shape of a segmented arc to naturally accommodate and support the frog and sole of the horse hoof. Accordingly, horse sole bed 20 directly receives and support the horse hoof. To improve hoof traction on horse sole bed 20, the upper surface of the horse sole bed 25 can be provided with a textured surface, as shown in FIG. 5. Further, distal end 30 is shaped to receive the toe 3 of a horse hoof, as illustrated in FIG. 12. Likewise, proximal end 40 is sized to receive the heel of a horse hoof.

Additionally, sole 25 includes a frog support 74 that flexibly accommodates the natural expansion and contraction of the horse frog. In the area that corresponds with the sole of the horse hoof, horse shoe 10 optionally includes a stratum 90, which provides added hoof protection and strength. Stratum 90 may be provided with one or more stratum openings 94. Such openings 94 permit egress of water and debris from the bottom of the horse shoe. In another embodiment of the present invention, horse shoe 10 can be provided with an opening instead of stratum 90. In another embodiment, sole 25 can be provided with fenestrations or openings 104 to permit nailing the sole to the horse hoof for added securement.

In one embodiment the proximal end 40 of the shoe 10 is a material that can be shaved, such as urethane. This permits a user to precisely shave platform 20 to conform to the size and shape of the horse heel. The more precise proximal fit reduces the likelihood of the shoes interfering with a horse's gallop or other movement.

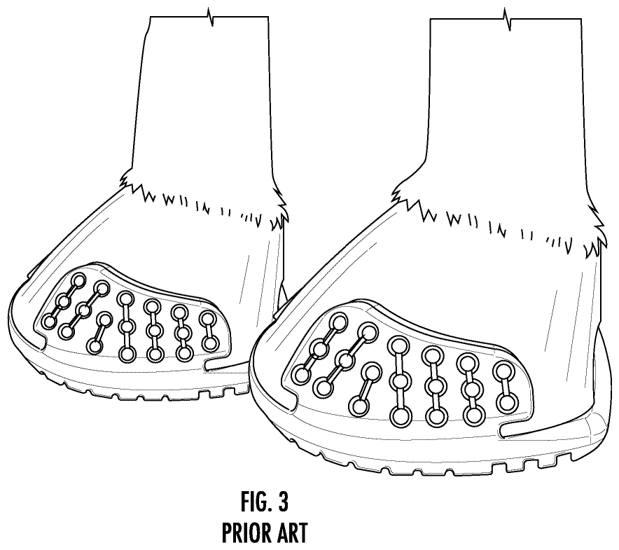

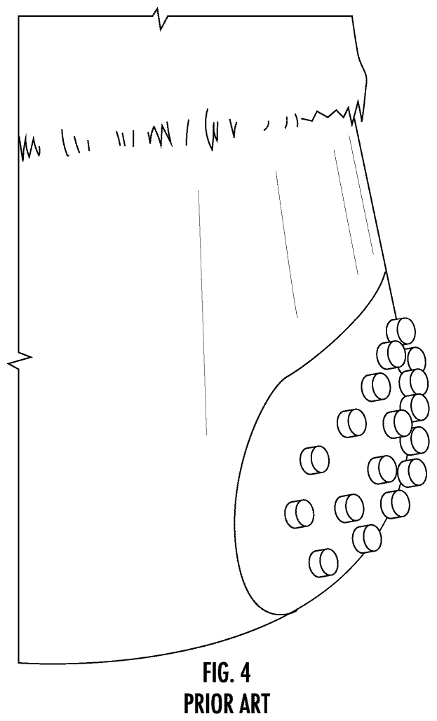

To fit horse shoes 10 of the embodiment shown in FIGS. 3-12, a user must first size each hoof. This can be accomplished by measuring the width and length of each hoof with a fit-kit, such as supplied by Easycare, Inc. Based on the width and length of each hoof, a shoe of a proper size is selected. Upon selection, the horse hoof is first prepared using traditional hoof care methods. For example, to ensure proper adhesion, the hoof can be roughed using a rasp or other appropriate tool and cleaned of dust, preferably three times.

Once the horse shoes are sized to each hoof, and each hoof is prepared, each horse shoe is adhered to the respective hoof with gap-filing adhesive. Suitable gap-filling adhesives include both urethane and acrylic based adhesives. To secure horse shoe 10 to a horse hoof, a user dispenses an abundant amount of adhesive into interior space 68; and in any event enough adhesive to more than fill interior space 68. The user then inserts the horse hoof into the horse shoe (or vice versa), and squeezes/presses out excess adhesive, primarily through holes 70. During this step, rim 64 ensures that a substantial amount of adhesive is retained in interior space 68. The excess adhesive squeezed through holes 70 is then smoothed into frustroconical regions 78 and channels 72.

To ensure the horse shoe remains in place during curing, the horse shoe can be temporarily secured to the hoof with plastic wrap. Once the glue or adhesive fully dries/cures, the plastic wrap can be removed. Referring to FIG. 12, horse shoe 10 is shown adhered to hoof wall 2 of a horse hoof 1 with toe 3 extending to proximal end 30. As depicted, the cured adhesive forms nodes 80 and adhesive laces 84 that materially increase the retention strength of the adhesive and, ultimately, horse shoe 10. Once adhered to the hoof, the proximal end of the platform can be shaved into a shape that corresponds with the horse hoof. The process is repeated for each hoof.

To manufacture shoe 10, the polymer upper and sole can be created from one or more aluminum blanks machined into the precise configurations shown in FIGS. 5-12.

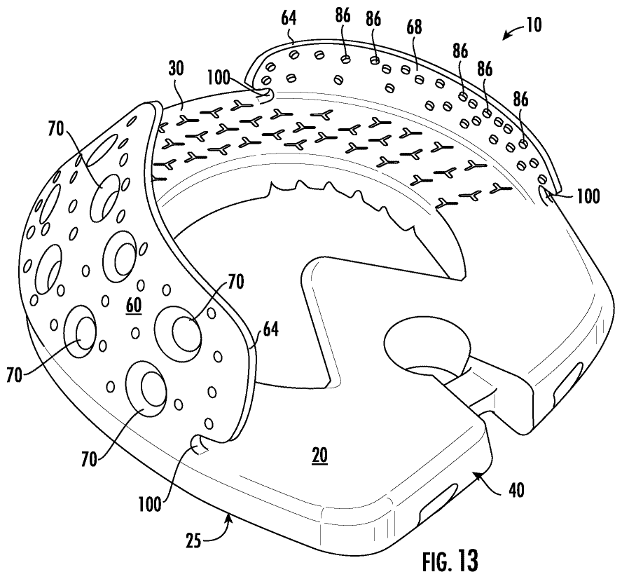

Referring to generally to the drawings, FIGS. 13-19 disclose a horse shoe 10 having a sole, lateral cuffs that correspond with horse hoof anatomy, and liners that snap-fit or friction-fit correspondingly into the cuffs. In use, a cyanoacrylate-style adhesive is applied to the liners, which are then snap-fit into the cuffs. The adhesive is also applied to the portion of the liner that corresponds with the hoof, and then the exposed liner portion is adhered to the horse hoof with the adhesive.

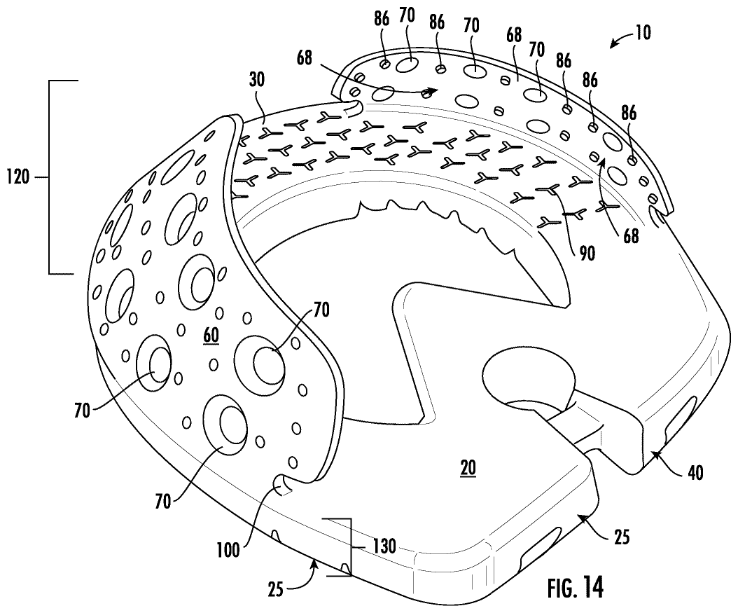

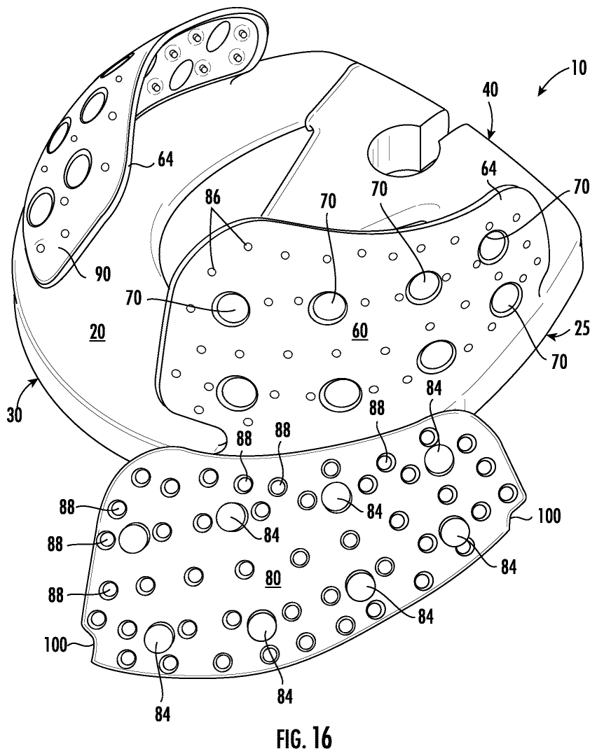

As best shown in FIGS. 13-15 and 19, horse shoe 10 includes a superior region 120 and an inferior region 130 between a distal end 30 and a proximal end 40. Superior region 120 includes curved lateral walls or cuffs 60 that extend in a superior direction from sole bed 20. The borders of cuffs 60 include an interior facing lip or rim 64 that defines an interior space 68 between the horse hoof and cuff 60 when in use. Cuff 60 further includes holes 70 and a number of interior pins 86, which provide structure and support between cuff 60 and the horse hoof. In addition, as shown in FIG. 14, inferior region 130 includes a lower horse sole bed 20, sole 25 and treads 110, which provide for improved traction. Sole 25 can be provided with nail fenestrations 190 (FIGS. 13 and 16), which permit nailing horse shoe 10 to a horse hoof. In one preferred embodiment, the horse shoe is formed from a polymer having a durometer between 80 A and 90 A.

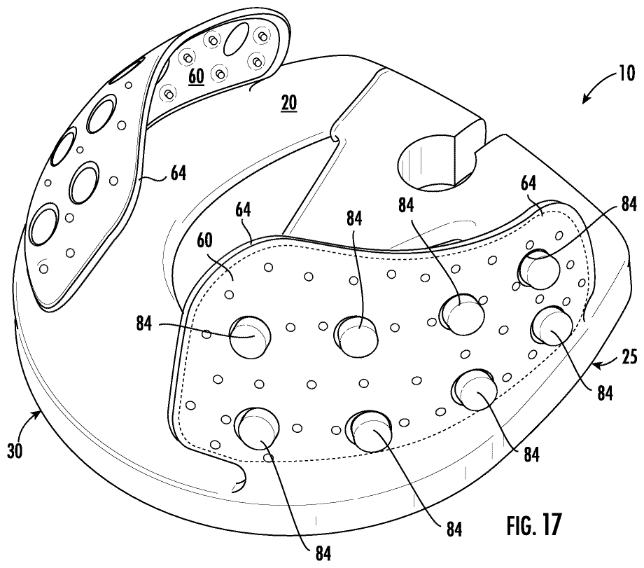

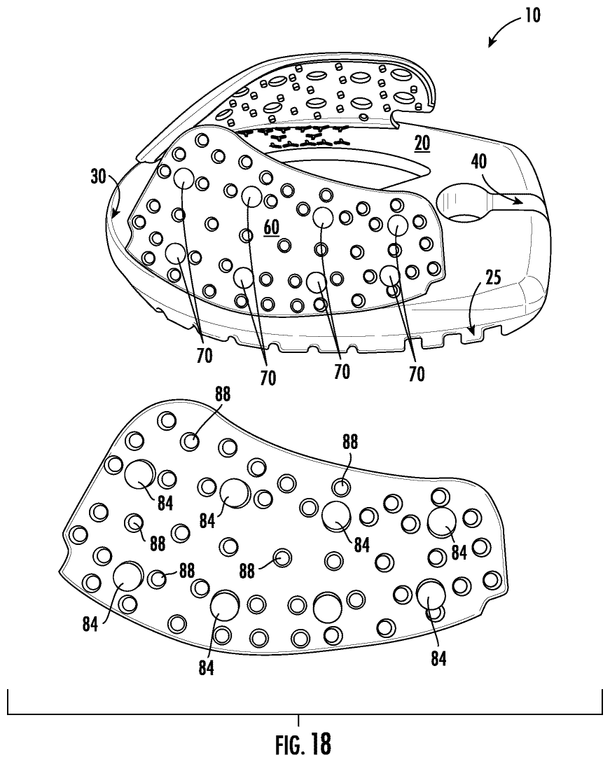

Horse shoe 10 further includes, as shown in FIGS. 17 and 18, an interior liner 180. In one preferred embodiment, the interior liner can be formed from a material having a durometer equal or up to 10a less than the durometer of the shoe. Additionally, interior liner 180 is provided in chiral varieties corresponding with a left and right orientation. Accordingly, a liner 180 corresponds with and fits into a left cuff, and a chiral of liner 180 corresponds and fits into the right cuff.

As shown in FIG. 17, liner 180 is preferably provided with an outer perimeter 82 having carveouts 100. Liner 180 snap-fits, press-fits or torsion-fits to cuff 60. Further, liner 180 includes a number of pegs 184 that snap-fit or press-fit into holes 70, and a plurality of dimples, holes or recesses 88 that correspond with and accommodate interior pins 86. In use, liner 180 can be secured to cuff 60 with or without adhesive. That is, liner 180 can be snapped onto cuff 60 with adhesive for a more permanent connection between liner 180 and cuff 60. Alternatively, liner 180 can be snapped or press fit onto cuff 60 without adhesive. The retaining or friction force of pegs 184 once inserted into holes 70 is sufficient to fully secure liner 180 to cuff 60. Such a glue-less attachment of pegs 184 to cuff 60 permits a user to selectively attach and remove the horse shoe 10 from a horse hoof.

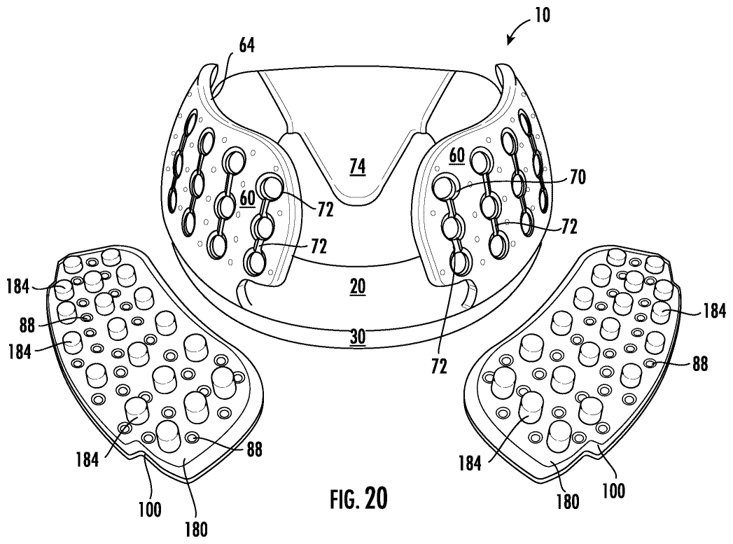

FIGS. 20-26 illustrate another embodiment of horse shoe 10, including cuffs 60 and liner 180. Further, cuffs 60 have holes 70 extending through the cuffs, as well as a series of exterior, vertical furrows, grooves or channels 72. Liner 180 has pegs 184 and recesses 88.

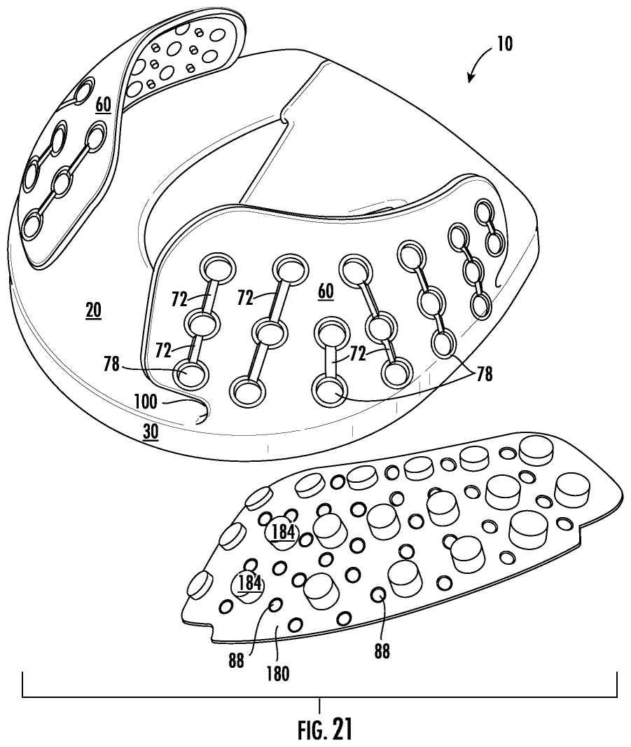

As shown in FIGS. 21, this embodiment of horse shoe 10 can be used without liners 180. That is, as detailed above, the horse shoe 10 is adhered to a horse hoof with only a gap-filling adhesive. To secure horse shoe 10 to a horse hoof, a user dispenses an abundant amount of gap-filling adhesive into interior space 68; and in any event enough adhesive to more than fill interior space 68. The user then inserts the horse hoof into the horse shoe (or vice versa), and squeezes/presses out excess adhesive, primarily through holes 70. During this step, rim 64 ensures that a substantial amount of adhesive is retained in interior space 68. The excess adhesive squeezed through holes 70 is then smoothed into frustoconical regions 78 and channels 72.

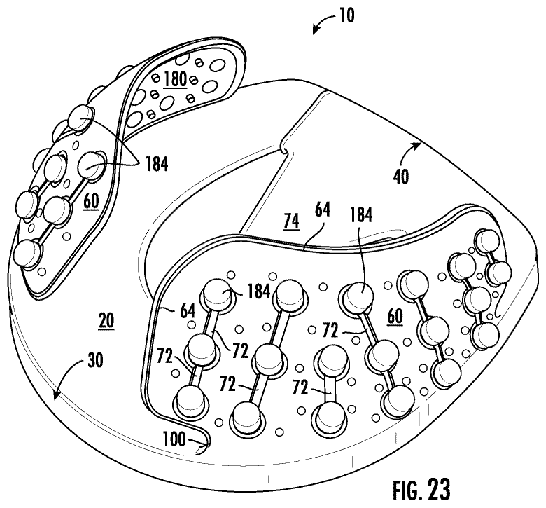

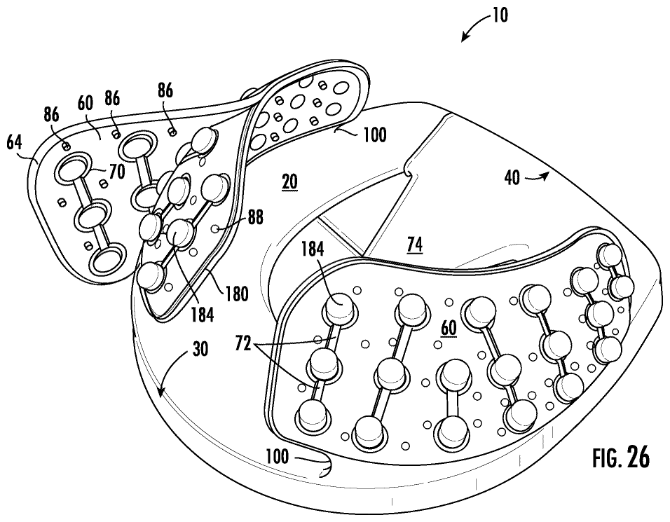

Alternatively, as depicted in FIGS. 23 and 26, horse shoe 10 can be used with liners 180. To use horse shoe 10 with liners 180, a user first snap-fits or press-fits the liners to cuff 60. The interior surface of liner 180, which is in contact with the horse hoof, is then coated with a suitable amount of cyanoacrylate style adhesive, pressed to the exterior surface of the hoof and allowed to cure. To allow suitable curing time, a plastic wrap can be used to hold the horse shoe in place during curing. As shown in FIG. 26, to remove the horse shoe from the hoof, a user can peel away cuff 60 from the liner, leaving the liner adhered to the hoof. To reattach the horse shoe to the hoof, the user can then snap-fit or press-fit the cuff back onto the liner. This permits a user to swap horse shoes with different traction profiles, replace worn horse shoes, or simply allow the horse to go “barefoot” with only a liner(s) on the hoof. In the event a user prefers a more permanent connection, cyanoacrylate style adhesive can also be added to the surface of the liner that is in communication with the cuff, thus permanent adhering the liner to the cuff.

In another embodiment, a horse shoe 10 is offered as a kit. The kit includes a horse shoe 10, including liners 180, as shown in FIGS. 5-26. The kit is also provided with a tube of adhesive, such as cyanoacrylate or a gap-filling adhesive such as urethane or acrylic based adhesives. The kit further includes use instructions regarding how to securely and safely attach the horse shoe to a horse hoof, and in one embodiment, how to properly remove the horse shoe from the horse shoe, which will be apparent to one of ordinary skill in the art in view of the present disclosure. The instructions for use can be provided as a QR code link to an instructional video. In addition, the kit may be provided with a plastic wrap to secure the horse shoe to the horse hoof while the adhesive cures on the horse hoof.

This disclosure describes various elements, features, aspects, and advantages of various embodiments and examples and configurations thereof of composite compositions. It is to be understood that certain descriptions of the various embodiments have been simplified to illustrate only those elements, features and aspects that are relevant to a more clear understanding of the disclosed embodiments, while eliminating, for purposes of brevity or clarity, other elements, features and aspects. Any references to “various embodiments,” “certain embodiments,” “some embodiments,” “one example,” “one embodiment,” “an example,” or “an embodiment” generally means that a particular element, feature and/or aspect described in the embodiment is included in at least one embodiment. The phrases “in various embodiments,” “in certain embodiments,” “in some embodiments,” “in one embodiment,” or “in an embodiment” may not refer to the same embodiment.” Furthermore, the phrases “in one such embodiment” or “in certain such embodiments,” or “in one example,” while generally referring to and elaborating upon a preceding embodiment, is not intended to suggest that the elements, features, and aspects of the embodiment introduced by the phrase are limited to the preceding embodiment; rather, the phrase is provided to assist the reader in understanding the various elements, features, and aspects disclosed herein and it is to be understood that those having ordinary skill in the art will recognize that such elements, features, and aspects presented in the introduced embodiment may be applied in combination with other various combinations and sub-combinations of the elements, features, and aspects presented in the disclosed embodiments. It is to be appreciated that persons having ordinary skill in the art, upon considering the descriptions herein, will recognize that various combinations or sub-combinations of the various embodiments and other elements, features, and aspects may be desirable in particular implementations or applications. However, because such other elements, features, and aspects may be readily ascertained by persons having ordinary skill in the art upon considering the description herein, and are not necessary for a complete understanding of the disclosed embodiments, a description of such elements, features, and aspects may not be provided. As such, it is to be understood that the description set forth herein is merely exemplary and illustrative of the disclosed embodiments and is not intended to limit the scope of the invention as defined solely by the claims.

What is claimed is:

1. A horse shoe, comprising:
a horse sole bed;
a first cuff extending from the bed, the cuff having a first opening and a second opening; and
a rim extending from the cuff, the rim defining a cuff interior space.

2. The horse shoe of claim 1, further comprising a first adhesive channel extending between the first and second openings.

3. The horse shoe of claim 2, further comprising a plurality of additional openings disposed through the first cuff, and a plurality of adhesive channels connecting the plurality of additional openings.

4. The horse shoe of claim 2, further comprising a second cuff extending from the bed, the second cuff having a third opening and a fourth opening;
a second adhesive channel extending between the third opening and the fourth opening; and
a rim extending from the second cuff, the rim defining a second cuff interior space.

5. The horse shoe of claim 4, wherein the first and second cuffs are formed from a polymer having a durometer between 80 A and 90 A.

6. The horse shoe of claim 4, further comprising a plurality of additional openings disposed through the second cuff, and a plurality of adhesive channels connecting two or more of the plurality of additional openings.

7. The horse shoe of claim 6, wherein at least one of the openings is frustoconical.

8. The horse shoe of claim 2, further comprising a gap-filling adhesive adhered to the interior space, the first and second openings, and the adhesive channel.

9. The horse shoe of claim 1, further comprising a liner mated to the first cuff, the liner having a peg mated to one of the first and second openings.

10. The horse shoe of claim 9, wherein the liner comprises a plurality of recesses, and the first cuff has a plurality of pins that extent into the plurality of recesses.

11. A horse shoe comprising:
a shoe formed from a polymer having a durometer between 80 A and 90 A, the shoe having a horse sole bed;
a first lateral cuff extending from the horse sole bed, the first lateral cuff defining an outer perimeter;
a rim disposed along the outer perimeter of the first lateral cuff, the rim defining an interior space;
a second lateral cuff extending from the horse sole bed, the second lateral cuff defining an outer perimeter;
a second rim disposed along the outer perimeter of the second lateral cuff, the second rim defining a second interior space; and
a frog support extending from the horse sole bed.

12. The horse shoe of claim 11, further comprising:
a plurality of openings disposed through the first cuff; and
a liner, the liner having a plurality of pegs extending from the liner, wherein the plurality of pegs are mated to the plurality of openings in the first cuff.

13. The horse shoe of claim 12, further comprising:
a plurality of openings disposed through the second cuff; and
a second liner, the second liner having a plurality of pegs extending from the second liner, wherein the plurality of pegs in the second liner are mated to the plurality of openings in the second cuff.

14. The horse shoe of claim 13, wherein the pegs extending from the first liner are friction fit to the openings of the first cuff, and the pegs extending from the second liner are friction fit to the openings of the second cuff.

15. The horse shoe of claim 13, wherein the pegs extending from the first liner are snap-fit to the openings of the first cuff, and the pegs extending from the second liner are snap-fit to the openings of the second cuff.

16. A kit for use in securing a horse shoe to a horse, the kit comprising:
a horse shoe comprising:
a sole formed from a polymer having a durometer between 80 A and 90 A, the sole forming a horse sole bed;
a cuff extending from the horse sole bed, the cuff defining an outer perimeter, and an opening;
a rim disposed along the outer perimeter of the cuff, the rim defining an interior space; and
a frog extending from the horse sole bed;
a liner, and a peg extending from the liner, the peg being sized to be friction fit in the opening of the cuff;
a tube having an adhesive; and
user instructions for properly securing and removing the horse shoe from a horse hoof.

17. The kit of claim 16, wherein the adhesive is one of cyanoacrylate, urethane and acrylic adhesive.

18. The kit of claim 16, further comprising a second liner and a peg extending from the second liner.

19. The kit of claim 18, wherein the second tube of adhesive is one of cyanoacrylate, urethane and acrylic adhesive.

20. The kit of claim 19, further comprising a plastic wrap.
